(19) United States
(12) Patent Application Publication
(10) Pub. No.: US 2005/0251609 A1
(43) Pub. Date: Nov. 10, 2005

(54) Removable peripheral device

(76) Inventors: Horng-Yee Chou, Palo Alto, CA (US); Sun-Teck See, San Jose, CA (US)

Correspondence Address: FORTUNE LAW GROUP LLP, 100 CENTURY CENTER COURT, SUITE 315, SAN JOSE, CA, 95112, US

(21) Appl. No.: 10/839,648

(22) Filed: May 4, 2004

(51) Int. Cl. G06F 3/00

(52) U.S. Cl. 710/313

(57) ABSTRACT

A peripheral device coupleable to an ExpressCard™ interface of a host system includes an ExpressCard™ portion and a second portion coupleable to the ExpressCard™ portion. Functionality of the peripheral device is partitioned between the ExpressCard™ portion and the second portion.

### BACKGROUND OF THE INVENTION

The present invention relates generally to host systems and peripheral devices and more particularly to a peripheral device having an ExpressCard™ portion attachable to a host system and a removable portion attachable to the ExpressCard™ portion.

The ExpressCard™ architecture was unveiled in September, 2003 by the PCMCIA (Personal Computer Memory Card International Association). ExpressCard™ leverages two conventional serial buses, USB 2.0 and PCI Express, to achieve space reduction and enhanced performance.

ExpressCard™ modules will be available in two sizes; a 34 mm wide module generally designated 100 is shown in FIG. 1 and a 54 mm wide module generally designated 200 is shown in FIG. 2. Both the 34 mm wide module 100 and the 54 mm wide module 200 are 75 mm long and 5 mm thick. A pin out of an ExpressCard™ module 300 is shown in FIG. 3.

The universal serial bus (USB) is a standard serial electrical interface within the ExpressCard™ standard. A pin out of an ExpressCard™ module 400 using only the USB interface is shown in FIG. 4.

The PCI Express bus is a high speed standard serial electrical interface within the ExpressCard™ standard. A pin out of the ExpressCard™ module 500 using only the PCI Express interface is shown in FIG. 5.

For long-term, non-volatile storage, two types of memory are typically employed. One type includes magnetic disk memory intended for mass storage with practically unlimited number of write operations. The other type includes semiconductor memory with no or limited number of write operations.

When mass storage is desired, magnetic disk drives, whether fixed or removable, are generally more economical and more amenable to write operations than solid-state memory. Typically, a computer system employs a combination of fixed and removable (floppy) magnetic disks. However, these are relatively slow, bulky and require high precision moving mechanical parts. Consequently, they are not rugged and are prone to reliability problems, as well as being slower and consuming significant amounts of power.

The undesirable features of magnetic disks have become even more acute with the advent of portable and mobile computing. Disk drives are obstacles in the quest towards greater portability and lower power consumption of computer systems.

Flash memory has become an important means for storing data as such memory provides the advantage of mobility and non-erasability. Flash memory is an extremely useful way of storing data for portable devices such as handheld devices. The convenience that flash memory provides gives it numerous advantages over traditional mass storage devices such as hard disks. Besides portability, flash memory further offers advantages such as low power consumption, reliability, small size and high speed.

Flash memory is non-volatile which means that it retains its stored data even after power to the memory is turned off. This is an improvement over standard random access memory (RAM), which is volatile and therefore looses stored data when power is turned off.

As the number of mobile, portable, and handheld devices grows, the popularity of flash memory increases. The most common type of flash memory is in the form of a removable memory card such as the ExpressCard™ modules 100 and 200. Removable cards allow the contents of the flash memory to be transferred easily between devices or computers. Cards using flash memory have unique properties and operating requirements that make their incorporation into host computer systems not straightforward. Typically, additional hardware, such as a controller, and software are required to control the operation of the flash memory card. In more sophisticated implementations, the flash memory card may communicate with a host via a standard disk drive interface, store data under a prescribed file structure compatible with a standard disk operating system, and handle any errors that may arise.

There is currently underway an effort to apply non-volatile flash memory systems to mass storage applications. For example, these systems are intended to replace either of the existing fixed or removable floppy magnetic disk systems, or both.

It is anticipated that ExpressCard™ modules will become popular in varied applications. One such application includes mass storage peripherals such as flash memory systems. Such systems preferably provide low cost systems for replacing floppy disks, tape, or film. To reduce the cost of a flash memory system implemented on a card, it is necessary to either integrate the controller chip with the memory chip, which requires simplification of the control functionality, or perform most of the control functions by a host CPU, which makes the card host dependent. As such there is a need in the art for a peripheral device having a first portion attachable to a host system and a second portion attachable to the first portion wherein a set of functional components are partitioned between the first and second portions. Such functional components preferably include control functions. Preferably the first portion includes an ExpressCard™ portion. Preferably the peripheral device further provides for the offloading of components from a host system in order to minimize the size and cost of the host system and to provide flexibility in system configuration.

### SUMMARY OF THE INVENTION

In accordance with one aspect of the invention, a peripheral device coupleable to a host system includes a first portion coupleable to the host system and a second portion coupleable to the first portion. Functionality of the peripheral device is partitioned between the first portion and the second portion.

In another aspect of the invention, a peripheral device coupleable to a host system having offloaded components includes a first portion including the offloaded components coupleable to the host system and a second portion coupleable to the first portion.

In yet another aspect of the invention, a peripheral device coupleable to an ExpressCard™ interface of a host system includes an ExpressCard™ portion and a second portion coupleable to the ExpressCard™ portion.

These and other feature, aspects, and advantages of the present invention will become better understood with reference to the following drawings, description, and claims.

### BRIEF DESCRIPTION OF THE DRAWINGS

FIG. 1 is a schematic representation showing a 34 mm ExpressCard™ module;

FIG. 2 is a schematic representation showing a 54 mm ExpressCard™ module;

FIG. 3 is a schematic representation showing a pin out of an ExpressCard™ module;

FIG. 4 is a schematic representation showing a pin out of an ExpressCard™ module using the USB interface;

FIG. 5 is a schematic representation showing a pin out of an ExpressCard™ module using the PCI Express interface;

FIG. 6 is a schematic representation showing an ExpressCard™ module coupleable to a host controller;

FIG. 6A is a schematic representation showing a module multi-personality serial bus interface system in accordance with the present invention;

FIG. 6B is a schematic representation showing a host system multi-personality serial bus interface system in accordance with the present invention;

FIG. 7 is a schematic representation showing a peripheral device coupled to a host system in accordance with the present invention;

FIG. 8 is a schematic representation showing an alternative embodiment of the peripheral device coupled to a host system in accordance with the present invention;

FIG. 9 is a schematic representation showing an alternative embodiment of the peripheral device coupled to a host system in accordance with the present invention;

FIG. 10 is a schematic representation showing an alternative embodiment of the peripheral device coupled to a host system in accordance with the present invention;

FIG. 11 is a schematic representation showing a peripheral device first portion having a hot unplug capability in accordance with the present invention;

FIG. 12 is a flow chart showing a hot unplug method in accordance with the present invention;

FIG. 13 is a schematic representation showing a peripheral device second portion having a hot unplug capability in accordance with the present invention;

FIG. 14 is a flow chart showing a method of detecting a peripheral device mode by a dual mode host system in accordance with the present invention;

FIG. 15 is a flow chart showing a method of detecting a peripheral device mode by a single mode host system in accordance with the present invention;

FIG. 16 is a flow chart showing a dual mode device power on sequence in accordance with the present invention;

FIG. 17 is a flow chart showing a single mode device power on sequence in accordance with the present invention;

FIG. 18 is a schematic representation of a mode switch, LEDs and associated circuitry in accordance with the invention;

FIG. 19 is a schematic representation of an alternative mode switch in accordance with the invention;

FIG. 20 is a schematic representation of an alternative LED circuit in accordance with the invention;

FIG. 21 is a schematic representation of a write protect circuit in accordance with the present invention;

FIG. 22 is a schematic representation of an alternative write protect circuit in accordance with the present invention;

FIG. 23 is a schematic representation of an alternative write protect circuit in accordance with the present invention;

FIG. 24 is a timing diagram showing the operation of a reset circuit in accordance with the present invention;

FIG. 25 is a schematic representation of a reset circuit in accordance with the present invention; and

FIG. 26 is an alternative schematic representation of a reset circuit in accordance with the present invention.

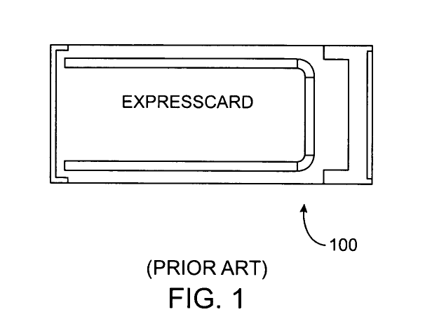

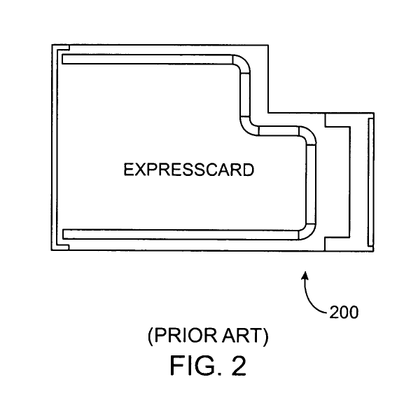

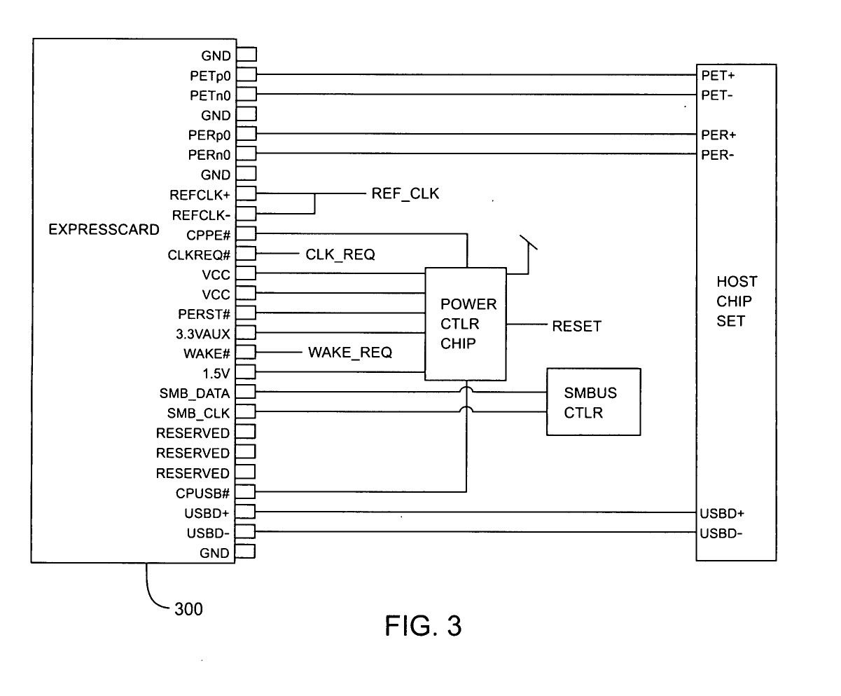

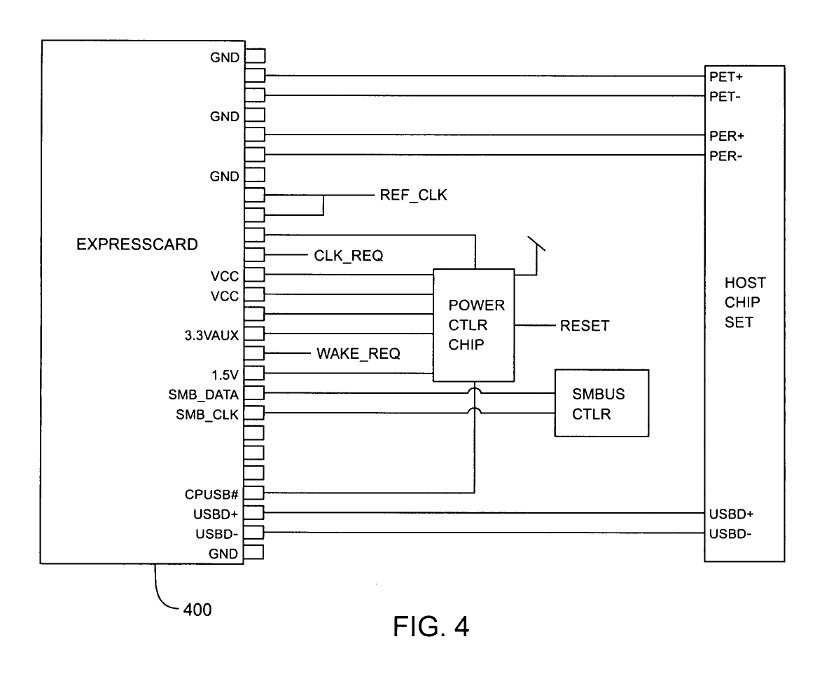

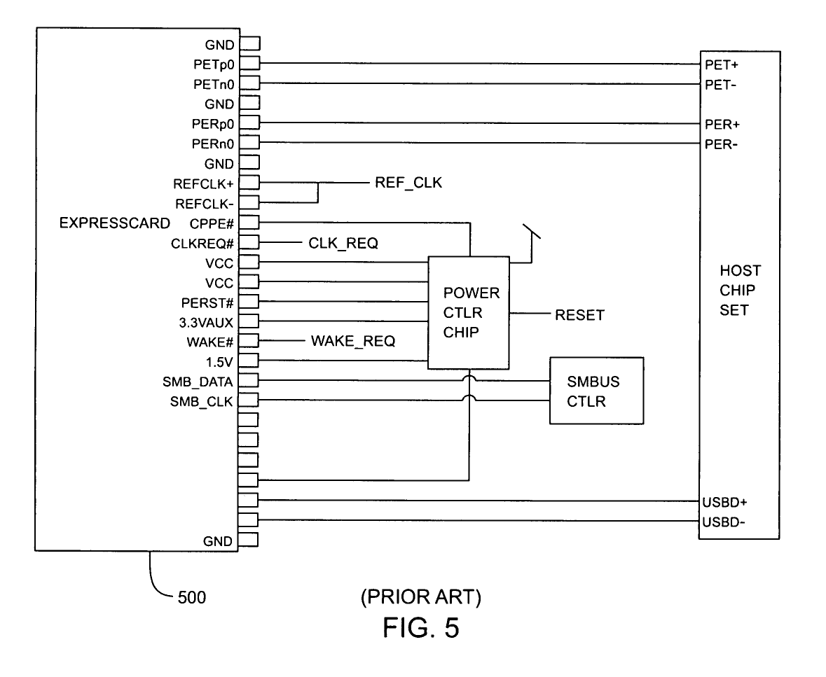

### DETAILED DESCRIPTION OF THE INVENTION

The following detailed description is of the best mode of carrying out the invention. The description is not to be taken in a limiting sense, but is made merely for the purposes of illustrating the general principles of the invention, since the scope of the invention is best defined by the appended claims.

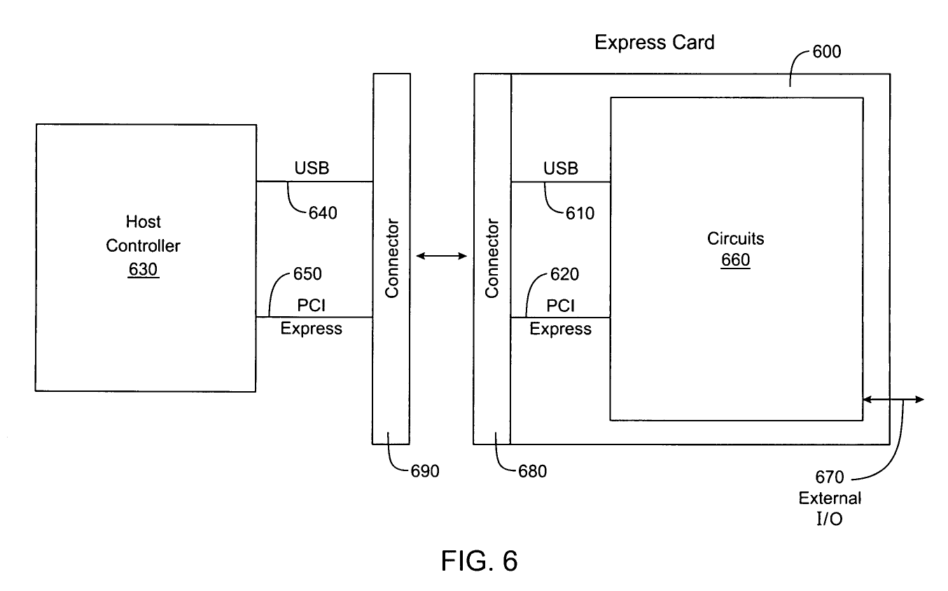

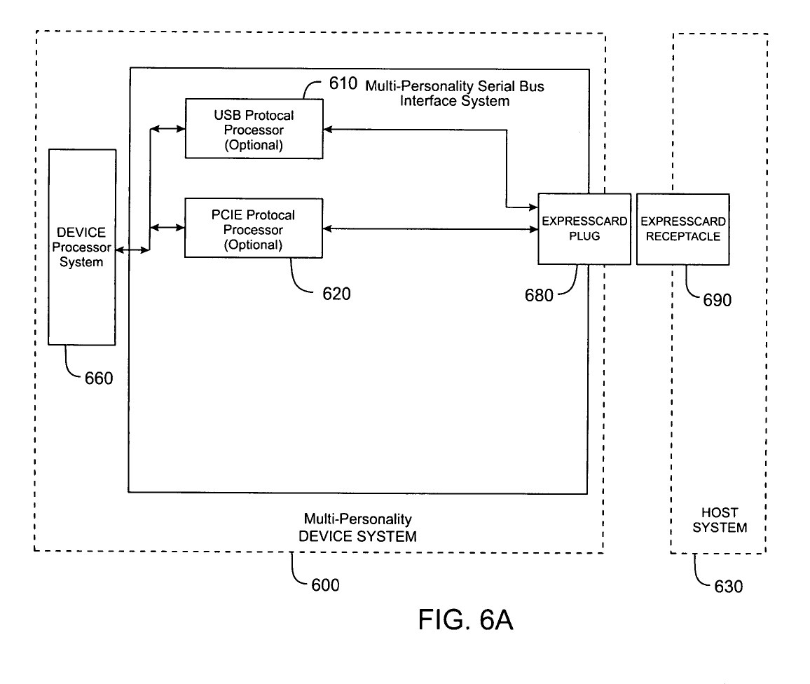

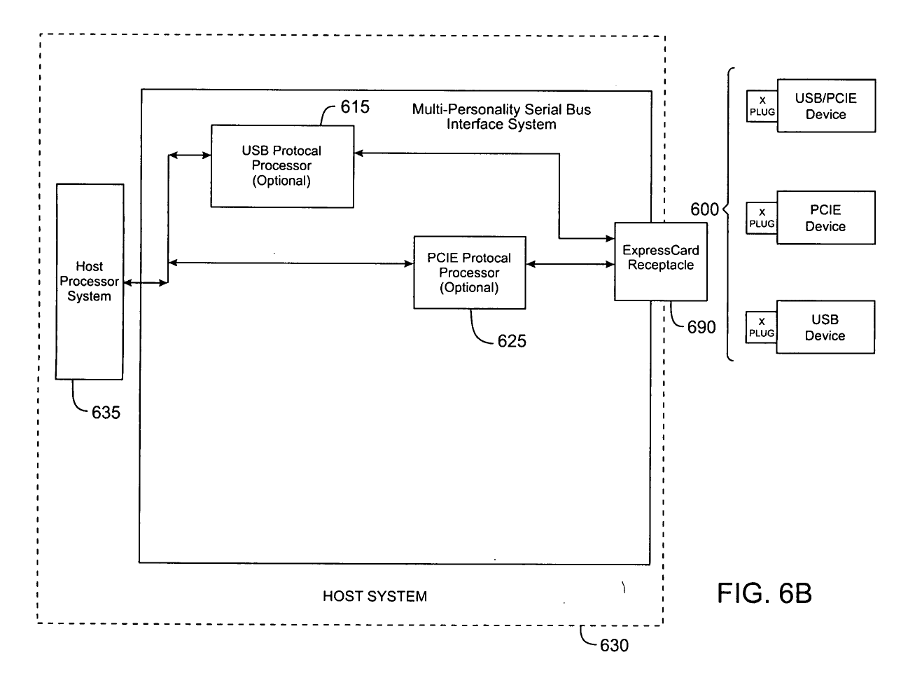

With reference to FIG. 6, there is shown an ExpressCard™ module 600 having a USB interface 610 and a PCI Express interface 620. A host controller 630 may support both a USB interface 640 and a PCI Express interface 650. ExpressCard™ module 600 may include circuit 660 which may include flash memory and a controller. Circuit 660 may include external I/O 670. An ExpressCard™ connector 680 may be coupled to a host controller connector 690. The ExpressCard™ module 600 is further described in commonly assigned patent application Ser. No. 10/746,935 entitled “Dual Mode USB and PCI Express Device” filed on Dec. 23, 2003 and incorporated herein by reference.

USB interface 610 and PCI Express interface 620 may be implemented in a module multi-personality serial bus interface system as shown in FIG. 6A including a USB protocol processor 610 and a PCI Express Protocol Processor 620. A host multi-personality serial bus interface system is shown in FIG. 6B including a USB protocol processor 615 and a PCI Express protocol processor 625 coupled to a host processor system 635.

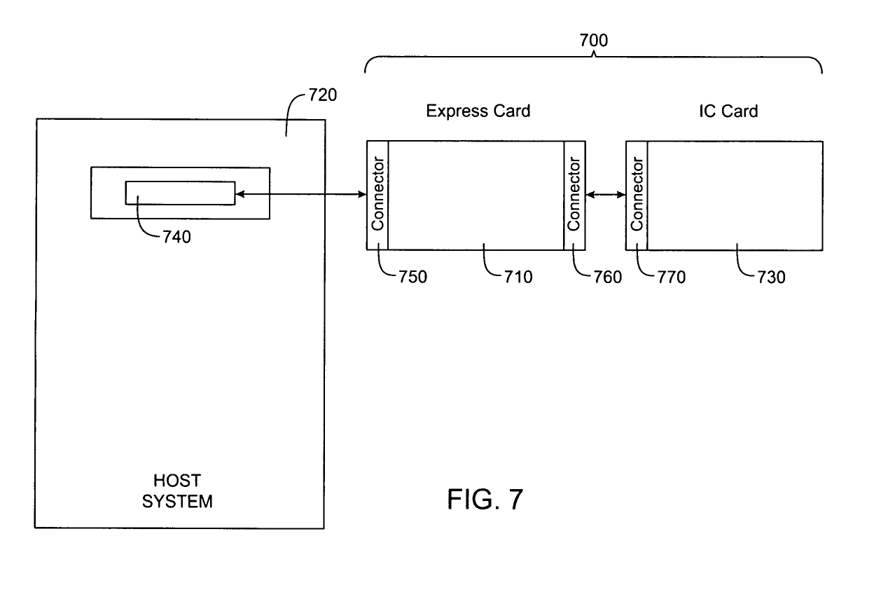

A peripheral device 700 having a first or mother portion 710 attachable to a host system 720 and a second or daughter portion 730 attachable to the first portion 710 is shown in FIG. 7. The first portion 710 may be an ExpressCard™ module 600. The second portion 730 may be an IC card as further described herein. Advantageously, a set of functional components are partitioned between the first and second portions 710 and 730 respectively.

The first portion 710 may be removably coupled to the host system 720 by means of a standard interface 740 that may provide both mechanical and electrical connection between the first portion 710 and the host system 720. Standard interface 740 may include a conventional 3.5 inch slot, a 5.25 inch slot, or a riser card. Standard interface 740 preferably includes an ExpressCard™ interface for coupling to a first portion first connector 750.

The electrical interface between the first portion 710 and the host system 720 may include the USB interface, the PCI Express interface or a dual mode interface.

The second portion 730 may be coupled to the first portion 710 by means of a second portion connector 770 coupleable to a first portion second connector 760. The connection between the first portion 710 and the second portion 730 may include a proprietary connection, MMC, SD, MS, XD, SM, CF, USB, PCI Express, SATA, SAS, and 1394. The connection may include a MX1 (multiple in one) or 1×1 (one in one) connection.

The second portion connector 770 generally includes pins that provide connections to ground, voltage supplies, serial/parallel data in and/or out, control lines, select lines, address lines, test pins as well as a signal that acknowledges the presence of the second or daughter portion 730. Depending on selective implementations of these pins, many pins or very few pins may be used in the second portion connector 770 and the first portion second connector 760. In a minimum pin implementation, data, addresses and commands are multiplexed into a serial stream before being passed across the second portion connector 770. Once across, the serial stream may be de-multiplexed into its respective components. As an example, this serial stream may be a PCI Express interface.

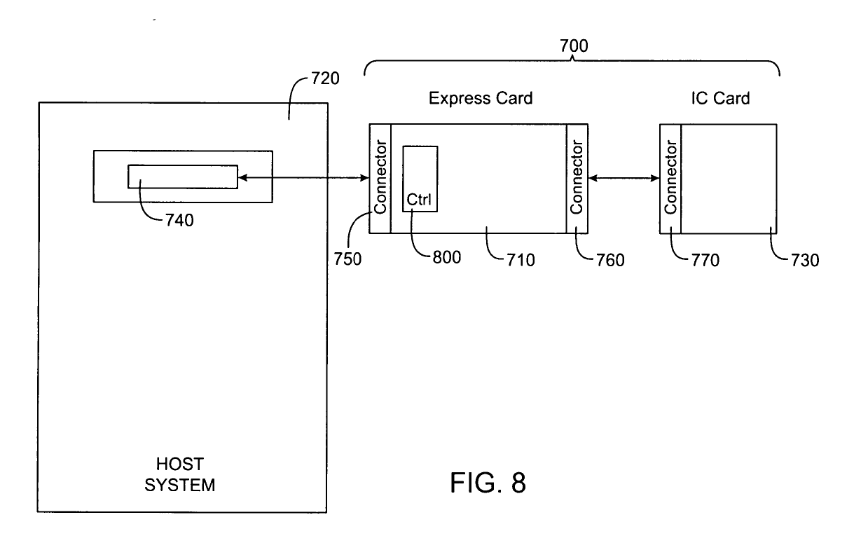

Partitioning the peripheral device 700 into a first portion 710 and a second portion 730 allows the functional components of the peripheral device 700 to be advantageously partitioned. According to one aspect of the invention, a peripheral implemented on the peripheral device 700 may include a flash memory system, including flash memory chips and supporting hardware circuits that form a controller 800 (FIG. 8) for controlling the operations of the flash memory and for interfacing to the host system 720. The flash memory system can be partitioned such that the controller 800 resides on the first portion 710 and the flash memory chips reside on the second portion 730.

In this manner, a cost-effective flash memory system is provided, especially in applications where magnetic floppy disks are to be replaced. In accordance with the invention, second portion 730, including IC cards containing only flash memory, may act essentially like a semiconductor flash memory “floppy disk” and need not have a controller on the second portion 730. The controller 800 on the first portion 710 may then serve any number of flash memory “floppy disks”. The cost of each flash memory “floppy disk” is therefore reduced by elimination of the controller on the “floppy disk” itself. Another advantage is an increase in system flexibility. A user may add or decrease memory capacity by choosing among second portion 730 IC cards with various amounts of installed memory. Also, with each update or upgrade of the controller 800, only the first portion 710 needs be replaced, the second portion 730 IC card “floppy disk” being fully usable with an updated or upgraded first portion 710.

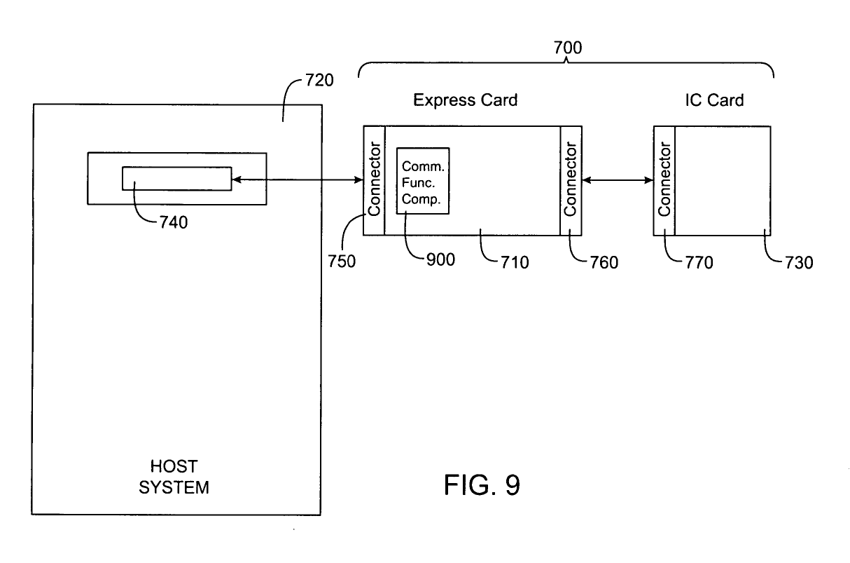

According to another aspect of the invention and with reference to FIG. 9, the peripheral device 700 may be implemented with a comprehensive first portion 710 including common functional components 900 of a number of peripherals. Each peripheral then has the remainder of the functional components residing on the second portion 730. For example, a magnetic hard disk, a modem, and a network adapter all have common functional components similar to that of a flash memory system, such as a host interface, a processor, and a ROM. By moving these common functional components to the first portion 710, each individual peripheral will have less components on the second portion 730, thereby reducing the cost of the peripheral.

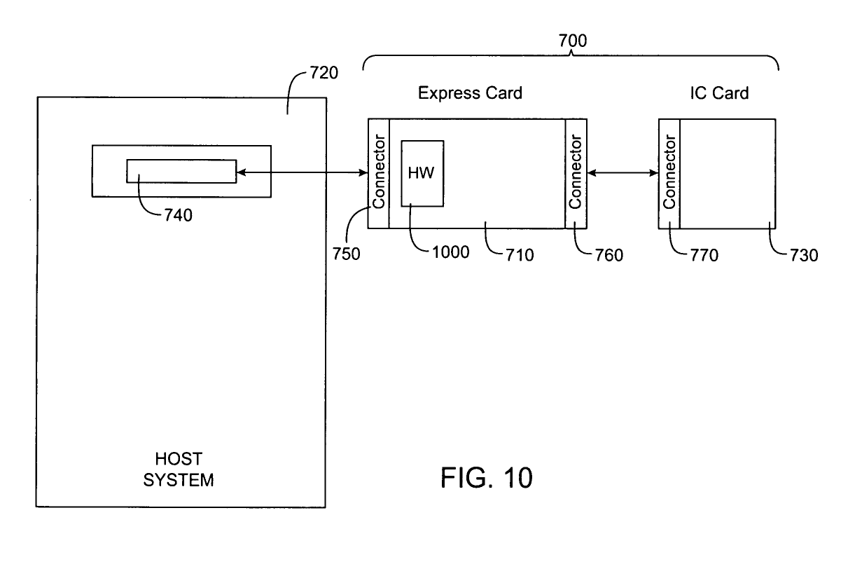

According to another aspect of the invention and with reference to FIG. 10, the peripheral device 700 may be implemented with some of the hardware 1000 originally residing in the host system 720 relocated to the first portion 710. Examples of such hardware may include system memory (DRAM, SRAM, or flash) or even the host microprocessor. The relocation of the hardware 1000 is advantageous because most small palmtop/notebook computers may not have sufficient room, such as motherboard space, to include enough system memory. Furthermore, these computers may be too small for users to open up and upgrade with memory SIMM modules. Also, most manufacturers prefer to ship out the lowest cost base unit with minimum memory. Such a low cost unit may be achieved by using the peripheral device 700 of the invention wherein the first portion 710 may include a controller and main memory, and the second portion 730 may include either a flash memory “floppy drive” or a small form factor magnetic hard disk (e.g. just the head, disk and motor assembly portions of a 1.8″ or 1.3″ hard disk without its controller logic), or even a miniature tape backup drive.

By way of example, a video recording and playback system may be implemented wherein the recording medium is served by a second portion 730 embodying non-volatile memory such as the flash memory. A host system may include a portable still video or a motion video camera with a controller and optional functional components built in. The controller may control the memory operation of the nonvolatile memory. The optional function components may include a data compression module for compressing video and/or audio data before storing them on the second portion 730.

After the second portion 730 has been recorded with video and/or audio data, the second portion 730 can be removed from the camera and played back on a host system 720 such as a personal computer or a microprocessor-based playback deck. The second portion 730 communicates with the host system 720 via a standard interface such as an ExpressCard interface. This is accomplished by having memory controller 800 implemented on first portion 710. First portion 710 may include an optional functional component 900 including a data decompression module for decompressing video and audio data to recover their original form.

In this example, the portable camera stores the compressed data with information necessary to decompress it on the second portion 730. When the second portion is being played back on a host system 720, the host system 720 or first portion 710 is then able to correctly decompress the data on the second portion 730.

In another implementation of peripheral device 700, the second portion 730 may include a Compact Flash card for use with a digital camera. A first portion 710 including an ExpressCard™ may be coupleable to the digital camera. The first portion 710 is further coupleable to a host system 720 including a notebook computer and a Card Reader.

In a further implementation, smaller memory cards including SM, SD, MMC and Memory Stick can be plugged into a Compact Flash sized card. A converter chip may be designed for each combination to convert to the Compact Flash interface standard. These kinds of Compact Flash cards can then be plugged into first portion 710.

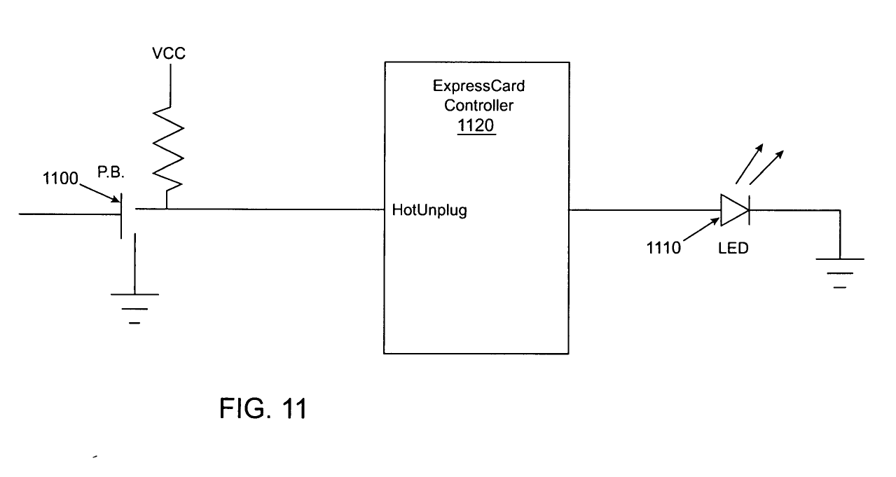

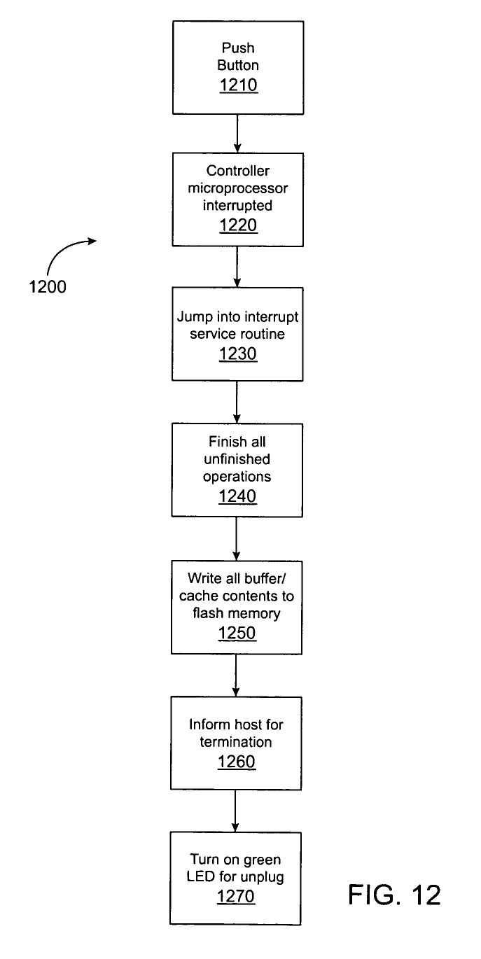

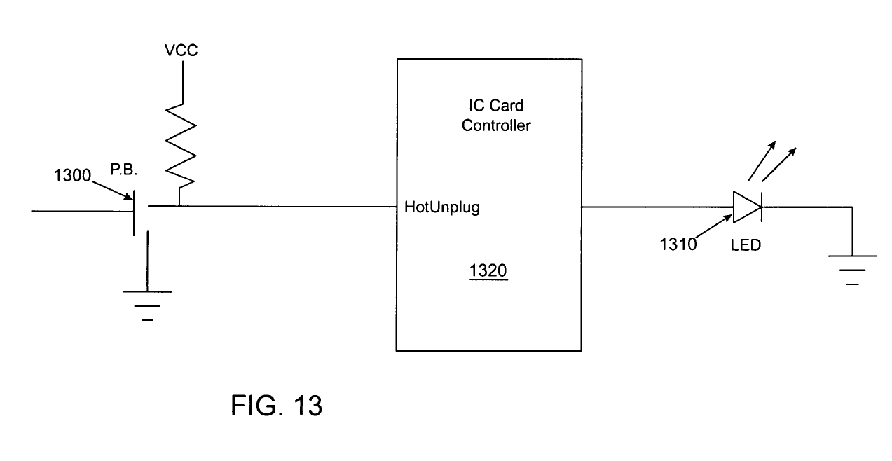

In another aspect of the invention, the first portion 710 and second portion 730 may be hot unplugable. With reference to FIG. 11, first portion 710 may include a push button switch generally designated 1100 and LED generally designated 1110 coupled to a first portion controller 1120. With reference to FIG. 13, second portion 730 may include push button switch generally designated 1300 and LED generally designated 1310 coupled to a second portion controller 1320. In order to hot unplug the first portion 710 from the host system 720, a method 1200 (FIG. 12) may include a step 1210 in which a user may push push-button switch 1100. An interrupt may thereby be created in a microcontroller within the first portion 710 in a step 1220. An interrupt service routine may then be initiated in a step 1230 and the microcontroller may finish all unfinished operations in a step 1240. If there are un-empty buffers and/or dirty caches, all of the contents of the buffers may be emptied and all dirty cache lines may be written back to the flash memory in a step 1250. The microcontroller may then notify the host system 720 of the termination in a step 1260. Finally, the microcontroller may turn on the LED 1110 to indicate to the user that the first portion 710 can be unplugged in a step 1270. When the host system 720 receives the termination notification, it may wait a fixed period of time before withdrawing power from the first portion 710 in order to allow the LED 1110 to be powered. Hot unpluging second portion 730 may be accomplished in a similar manner.

In order to unplug the first portion 710 from the host system 720 in a case where the PCI Express interface 650 is being used, handshake steps may be required between the first portion 710 and the host system 720 through a Hot Plug Service Utility. The steps of the Hot Plug Service Utility may include a user informing a host system's operating system that the first portion 710 may be removed. The utility may then command the host system's driver to stop using the first portion 710. The host system 720 may then assert a RST# signal to the first portion 710. The host system 720 may then command its chipset to enable the isolation logic in the host system 720. The host system 720 may then be isolated from a first portion bus. The LED 1110 may then be powered to indicate that the first portion 710 may safely be removed from the host system 720. After several seconds, power may be removed from the connector 690. The host system operating system may then free up memory space, I/O space, and interrupt lines assigned to the first portion 710 and make these resources available to other devices.

In order to hot plug a first portion 710 using the PCI Express interface 650, a host system chipset must have the ability to handle several software requests including selectively asserting and deasserting the PCI RST# signal to the connector 690. In addition, the host system chipset must be able to selectively isolate the first portion 710 from the logic on the host system board, and selectively remove or apply power to the card connector.

To hot plug the first portion 710 into host system 720 using the PCI Express interface 650, a user may inform a Hot Plug Service utility that the first portion 710 will be installed in connector 690. The host system 720 may command its chipset to set an LED in the host system (not shown) to indicate that the first portion may be safely inserted in the connector 690. The user may the insert the first portion 710 in connector 690. The host system 720 normally will detect that the first portion 710 is already inserted and may then turn off the LED to indicate that the first portion 710 must remain inserted in the connector 690. The host system may then apply the power to the connector 690 and activate the RST# signal. The isolation logic may then be turned off between the connector 690 and a first portion bus. After the isolation logic is disabled, the RST# signal is turned off and a Platform Configuration Routine lets the host system PCI Express Bridge perform PCI Express configuration accesses to the first portion 710. The configurations may be saved to host system memory or to Configuration Registers. After configuration, the host operating system may locate appropriate drivers for the functions within the first portion 710 and load the drivers into system memory. Configurations may include Vendor ID, Device ID, Class Code, Subsystem Vendor ID, and Subsystem ID.

To hot plug first portion 710 using USB interface 640, a hub (including host itself) where the first portion 710 is connected may inform the system host 720 that an event has occurred. There may be two 15K pull down resistors connected to D+ and D− USB wires in the hub port or root hub in the host system 720. When the first portion is connected, its pull-up resistor may cause the signal level of either D+ or D− to rise, thereby signaling the connection of the first portion 710. The first portion may then be considered to be in a connected stage. The host system 720 may inquire the hub for the nature of the event. The host system 720 may then send a Port Enable and Reset command to the hub where the first portion 710 is connected. The hub may the issue a USB reset signal to that port for 10 ms and provide 100 mA of power supply to the first portion 710. The first portion may then be considered to be in a powered stage. After the reset signal, the first portion 710 may be in its default stage where it communicates with the host system 720 with its default address (address 0 and endpoint 0). The host may then initiate a GET DESCRIPTOR setup packet to the first portion 710. The first portion 710 may reply with an ACK handshake packet to tell the host system 720 about the actual maximum data payload size the first portion 710 can handle. The host system 720 may then send a SET ADDRESS command.

Using the SET ADDRESS command, the host system may assign a unique address to the first portion 710. The first portion 710 may then be in an address stage. The host system 720 may then issue a second GET DESCRIPTOR (device) command in a case where the first GET DESCRIPTOR command is terminated prematurely. After the successful completion of the previous step, the host system 720 may issue a GET DESCRIPTOR (configuration descriptor type) setup packet to acquire the configuration of the first portion 710. Based on the configuration information received, the host system 720 may assign a configuration value to the first portion 710 via a SET CONFIGURATION setup packet. The first portion 710 may now be in a configured stage and ready for use.

In a case where both USB interface 640 and PCI Express interface 650 are available, USB interface 640 may be detected and initialized first. Then a host system driver may decide which interface to use. If the PCI Express interface 650 is chosen, then the PCI Express hot plug process may be executed.

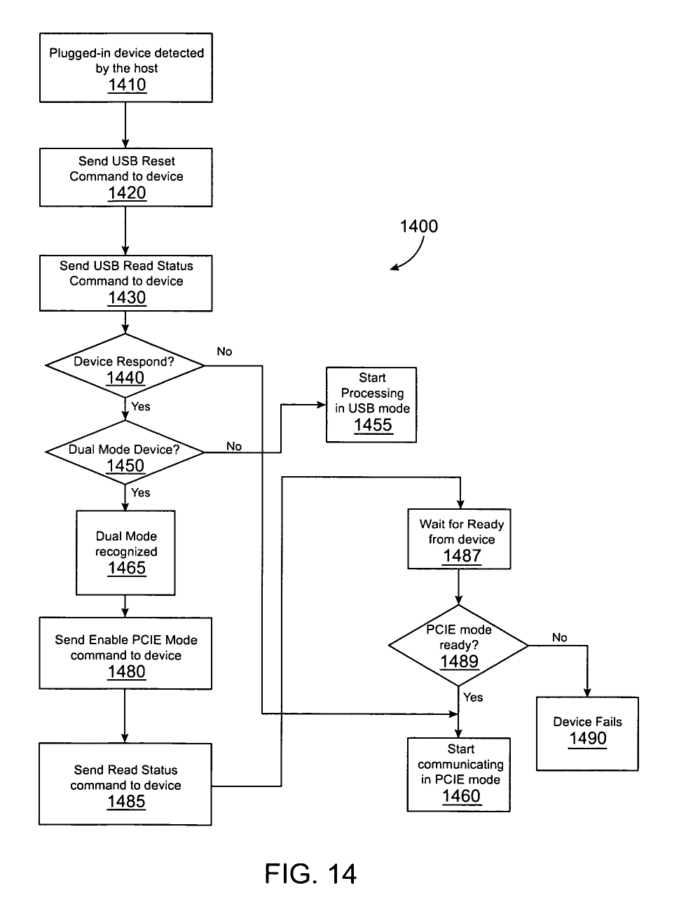

In accordance with another aspect of the invention, the host system 720 may be operable to detect the first portion 710. With reference to FIG. 14, a method 1400 includes a first step 1410 in which the host system 720 may detect the first portion 710. In a step 1420 the host system 720 may send a USB Reset command to the first portion 710 and in a step 1430 send a USB Read Status command. If the first portion 710 responds in a step 1440, then the host system 720 may detect whether the first portion 710 is a dual mode device in a step 1450. If the first portion 710 does not respond, then the host system 710 may initiate communication with the first portion 710 in PCI Express mode in a step 1460.

If the first portion 710 does not have the PCI Express mode, then the host system 720 may start processing in USB mode in a step 1455. If the first portion 710 is a dual mode device, then in a step 1465 the dual mode nature of the first portion is recognized. In a step 1480 the host system 720 may send an enable PCI Express Mode command to the first portion 710. The host system 720 may send a Read Status command to the first portion 710 in a step 1485. In a step 1487, the host system 720 may wait for a Ready command from the first portion 710. In a step 1489 the host system 720 may determine if the PCI Express mode is ready. If the PCI Express mode is not ready, then in a step 1490, the first portion 710 fails. If the PCI Express mode is ready, then in step 1460 the host system 720 starts communicating with the first portion 710 in PCI Express mode.

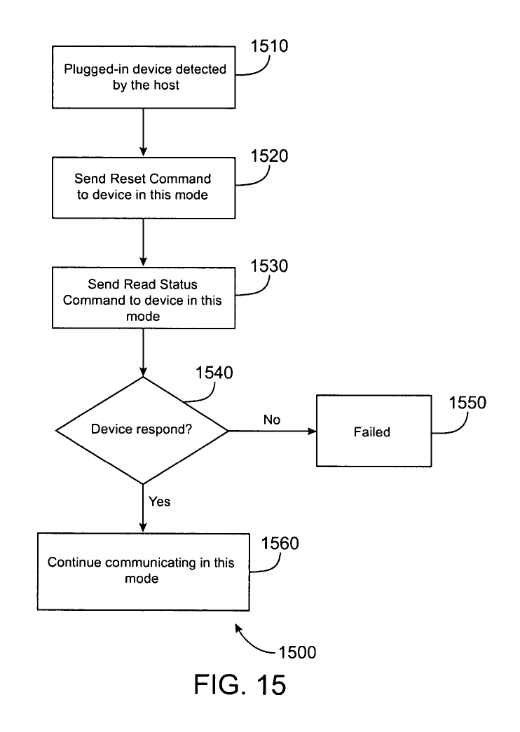

Host system 720 may only support one mode. Therefore, it may communicate with first portion 710 in either USB mode or PCI Express mode. With reference to FIG. 15, a method 1500 includes a step 1510 in which the host system 720 may detect the first portion 710. In a step 1520, the host system may send a Reset command to the first portion 710 in the mode of the host system 720 and in a step 1530 the host system may send a Read Status command. In a step 1540 the host system 720 may determine if the first portion 710 responds. If the first portion 710 does not respond, then the first portion 710 fails in a step 1550. If, on the other hand, the first portion 710 responds, then communication continues in the mode of the host system 720 in a step 1560.

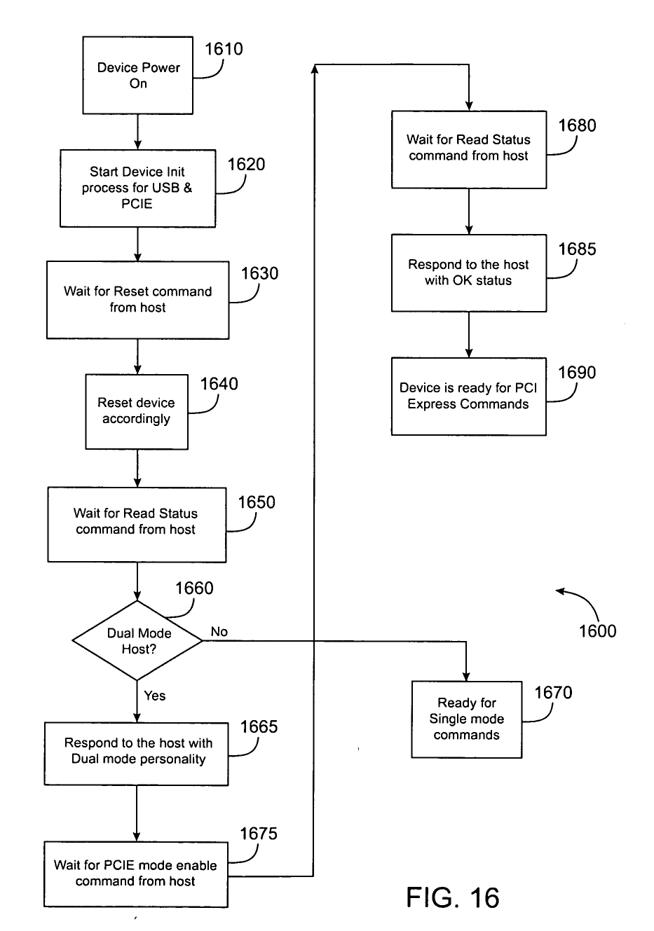

In another aspect of the invention, a dual mode first portion 710 may be operable to detect a mode of the host system 720. A method 1600 shown in FIG. 16 may include a step 1620 in which a first portion 710 is powered on. In a step 1620 a first portion initialization process may be started. The first portion 710 may wait for a Reset command from the host system 720 in a step 1630 and the first portion 710 may be reset in a step 1640. In a step 1650 the first portion 710 may wait for a Read Status command from the host system 720. In a step 1660 the first portion 710 may determine if the host system 720 is a dual mode host system. If the host system 720 is not a dual mode host system, then in a step 1670 the first portion 710 may be ready to receive single mode commands from the host system 720. If the host system 720 is a dual mode host system, then in a step 1665 the first portion 710 may respond to the host system 720 indicating that the first portion 710 is a dual mode device. In a step 1675 the first portion 710 may wait for a PCI Express mode Enable command from the host system. In a step 1680 the first portion 710 may wait for a Read Status command from the host 720. In a step 1685 the first portion 710 may respond to the host system with an OK status and in a step 1690 the first portion 710 may be ready to receive PCI Express commands from the host system 720.

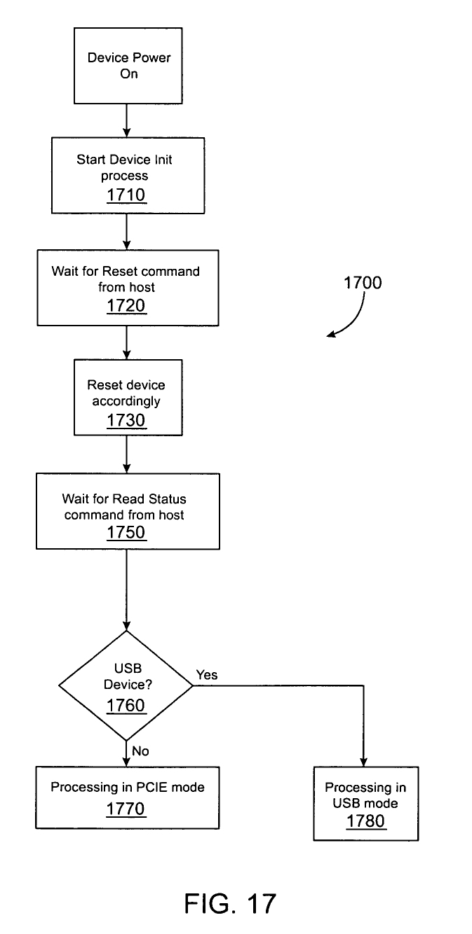

In the case where the first portion 710 is a single mode device, a method 1700 shown in FIG. 17 may be operable to establish communication with host system 720. In a step 1710 first portion 710 is powered on. First portion 710 initiation process may be started in a step 1720. In a step 1730, the first portion 710 may wait for a Reset command from the host system 720. The first portion 710 may be reset in a step 1740. In a step 1750 the first portion 710 may wait for a Read Status command from the host system. In a step 1760, the first portion 710 may determine if it is a USB device or not. If it is a USB device, then in a step 1780 processing may continue in USB mode. Otherwise, processing may continue in PCI Express mode in a step 1770.

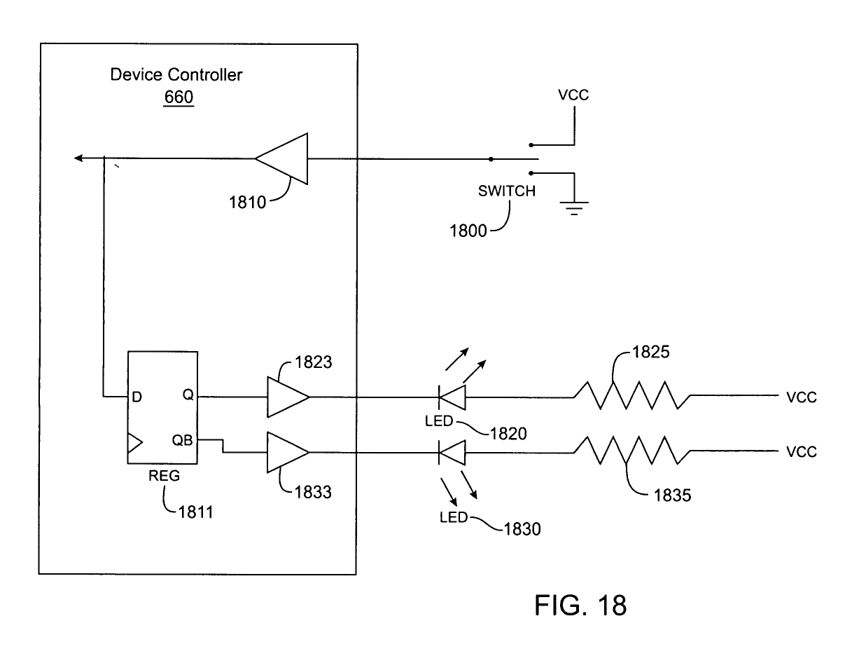

In an alternative embodiment of the invention and as shown in FIG. 18, a dual mode first portion 710 may include a switch 1800. Before first portion 710 is coupled to host system 720, USB or PCI Express mode may be selected by a user by operation of switch 1800. Detect circuit 1810 in circuit 660 may be operable to detect the selected mode and set a mode bit in a configuration register 1811. Each mode stored in the configuration register may be indicated by a corresponding LED 1820 or 1830. An LED 1820 circuit may include a buffer 1823 and a series resister 1825. An LED 1830 circuit may include a buffer 1833 and a series resistor 1835. Preferably the detect circuit 1810, register 1811 and buffers 1823 and 1833 are implemented in a general purpose input/output (GPIO) port.

By way of example, a USB mode of operation may be selected by setting switch 1800 to Vcc. PCI Express mode of operation may be selected by setting switch 1800 to ground. LED 1830 may be turned on when the USB mode is selected and LED 1820 may be turned on when PCI Express mode is selected.

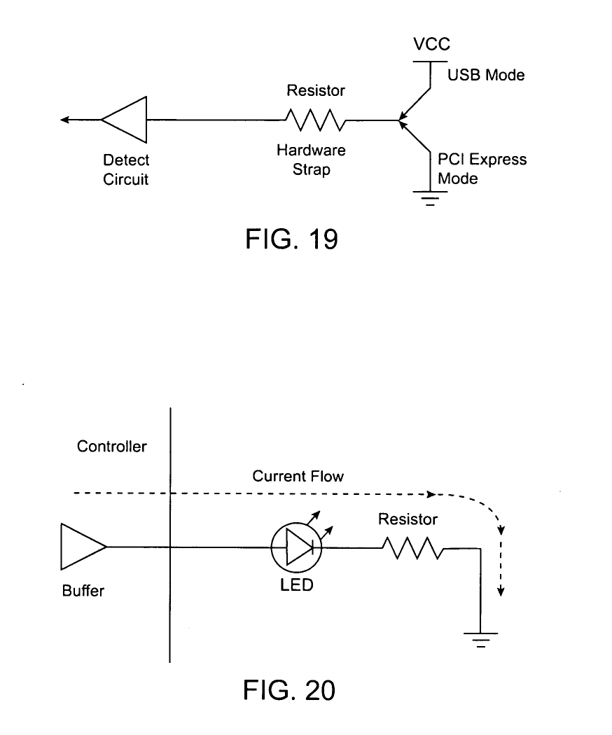

In another aspect of the invention, hardware strapping as shown in FIG. 19 may be used as a hardware switch.

In yet another aspect of the invention, LEDs 1820 and 1830 may be powered as shown in FIG. 20.

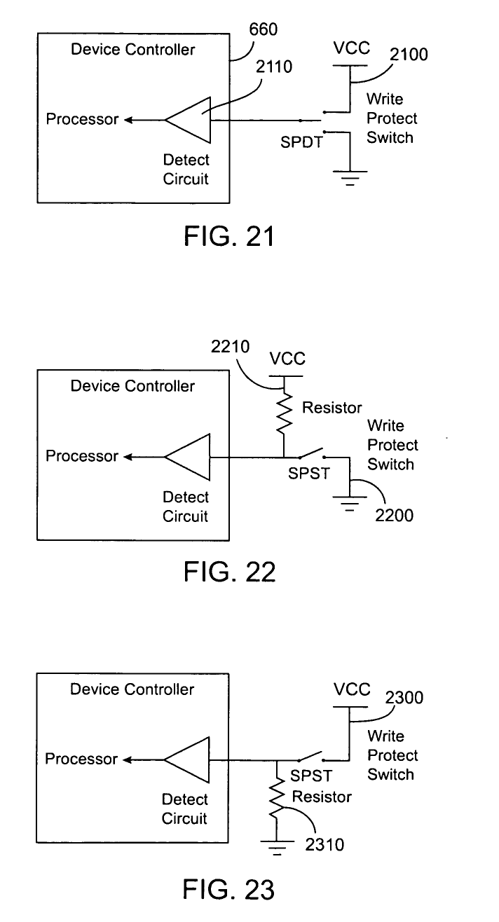

In another aspect of the invention, first portion 710 and second portion 730 may include write protect logic. Such write protect logic may include mechanisms to prevent the unintentional alteration of information stored in first and second portions 710 and 730. With reference to FIG. 21, a write protect switch 2100 may include a Single Pole Double Throw (SPDT) switch. A detect circuit 2110 of circuit 660 may be operable to detect a position of switch 2100. The detect circuit 2110 may be a GPIO port of circuit 660. A detected polarity may be used by a circuit 660 processor to govern a write attempt to the first and second portions 710 and 730. Alternative embodiments of write protect logic are shown in FIG. 22 (Single Pole Single Throw switch 2200 coupled to pull up resistor 2210) and FIG. 23 (SPST switch 2300 coupled to pull down resistor 2310).

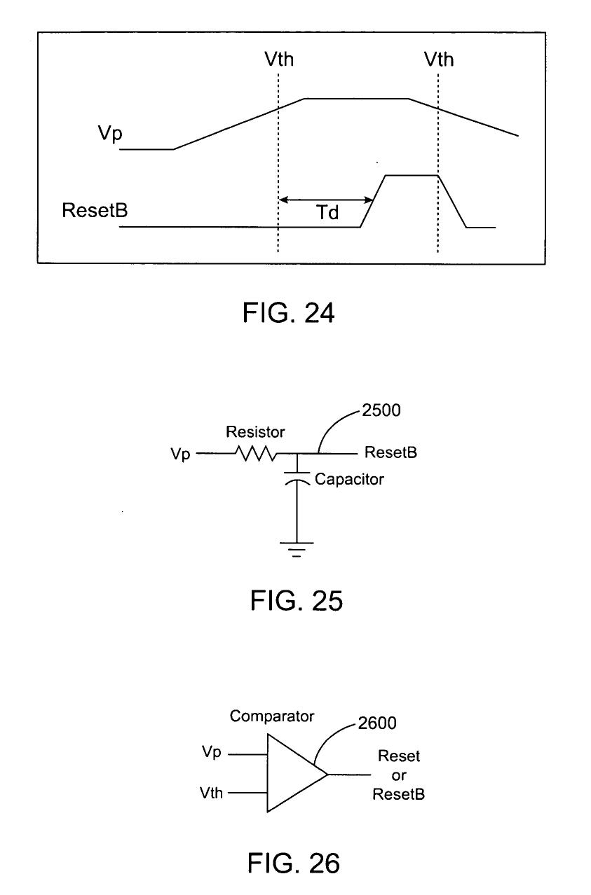

With reference to FIG. 24, FIG. 25 and FIG. 26, a reset circuit 2500, 2600 may be operable to monitor the power supply voltage of a system circuitry. The reset circuit 2500, 2600 may assert a reset signal ResetB whenever the power supply voltage drops below a threshold voltage (Vth) that may be fatal to system operation. Once asserted, the reset signal ResetB may remain active after the supply voltage rises above Vth for a time Td long enough for the system to stabilize. Reset circuit may be an RC circuit 2500 or a voltage comparator 2600. In circuit 2600, a divided supply voltage Vp is compared to Vth and ResetB is asserted whenever Vp is below Vth. The reset output may be either active high or active low. The reset output may be configured as either push/pull or open drain.

The peripheral device 700 of the present invention advantageously provides a peripheral device in the form of a card that is hot swappable and removably connected to a host system and that is cost-effective and flexible in configuration. The peripheral device 700 further provides a card with a specific type of semiconductor memory system having non-volatility, ease of erasing and rewriting, speed of access, and being compact, light-weight, low power, low cost, and reliable. The peripheral device 700 is advantageously removably coupled to the host system via a standard interface including the ExpressCard™ interface. Additionally, the peripheral device 700 of the present invention is adapted for use in a number of peripheral applications including replacing floppy disks, magnetic tapes, and photographic recording films. The peripheral device 700 further provides for the offloading of components from a host system in order to minimize the size and cost of the host system and to provide flexibility in system configuration. Finally, the peripheral device 700 provides a removable card that stores encoded data that can be decoded when the card is relocated from one host system to another.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A peripheral device coupleable to a host system comprising:
a first portion coupleable to the host system; and
a second portion coupleable to the first portion.

2. The peripheral device of claim 1, wherein the first portion is coupleable to the host system by means of an ExpressCard™ interface.

3. The peripheral device of claim 1, wherein the first portion comprises a controller and the second portion comprises a non-volatile memory.

4. The peripheral device of claim 1, wherein the first portion comprises a set of common functional components common to a device disposed on the second portion.

5. The peripheral device of claim 1, wherein the first portion comprises a push button switch and an LED coupled to a first portion controller.

6. The peripheral device of claim 1, wherein the second portion comprises a push button switch and an LED coupled to a second portion controller.

7. The peripheral device of claim 1, wherein the first portion comprises a mode of operation switch.

8. The peripheral device of claim 1, wherein the first portion comprises a write protect switch.

9. The peripheral device of claim 1, wherein the second portion comprises a write protect switch.

10. The peripheral device of claim 1, wherein the first portion is a 34 mm ExpressCard™ card.

11. The peripheral device of claim 1, wherein the first portion is a 54 mm ExpressCard™ card.

12. The peripheral device of claim 1, wherein the second portion is a Secure Digital card.

13. The peripheral device of claim 1, wherein the second portion is a mini Secure Digital card.

14. The peripheral device of claim 1, wherein the second portion is a Multi-Media Card.

15. The peripheral device of claim 1, wherein the second portion is a reduced size Multi-Media Card.

16. The peripheral device of claim 1, wherein the second portion is an XD card.

17. The peripheral device of claim 1, wherein the second portion is a Memory Stick card.

18. The peripheral device of claim 1, wherein the second portion is a Memory Stick Duo card.

19. The peripheral device of claim 1, wherein the second portion is a Memory Stick Pro card.

20. The peripheral device of claim 1, wherein the second portion is a Memory Stick Pro Duo card.

21. The peripheral device of claim 1, wherein the second portion is a Smart Media card.

22. The peripheral device of claim 1, wherein the second portion is a Micro Device card.

23. The peripheral device of claim 1, wherein the second portion is a Compact Flash card.

24. The peripheral device of claim 23, further comprising a memory card coupleable to the Compact Flash card.

25. A peripheral device coupleable to a host system having offloaded components comprising:
a first portion including the offloaded components coupleable to the host system; and
a second portion coupleable to the first portion.

26. The peripheral device of claim 25, wherein the first portion is coupleable to the host system by means of an ExpressCard™ interface.

27. The peripheral device of claim 25, wherein the offloaded components comprise host system memory.

28. The peripheral device of claim 25, wherein the offloaded components comprise a host microprocessor.

29. The peripheral device of claim 25, wherein the second portion comprises non-volatile memory.

30. The peripheral device of claim 25, wherein the first portion is a 34 mm ExpressCard™ card.

31. The peripheral device of claim 25, wherein the first portion is a 54 mm ExpressCard™ card.

32. The peripheral device of claim 25, wherein the second portion is a Compact Flash card.

33. The peripheral device of claim 32, further comprising a memory card coupleable to the Compact Flash card.

34. A peripheral device coupleable to an ExpressCard™ interface of a host system comprising:
an ExpressCard™ portion; and
a second portion coupleable to the ExpressCard™ portion.

35. The peripheral device of claim 34, wherein the ExpressCard™ portion comprises a controller and the second portion comprises a non-volatile memory.

36. The peripheral device of claim 34, wherein the ExpressCard™ portion comprises a set of common functional components common to a device disposed on the second portion.

37. The peripheral device of claim 34, wherein the ExpressCard™ portion is a 34 mm ExpressCard™ card.

38. The peripheral device of claim 34, wherein the ExpressCard™ portion is a 54 mm ExpressCard™ card.

39. The peripheral device of claim 34, wherein the second portion is a Compact Flash card.

40. The peripheral device of claim 39, further comprising a memory card coupleable to the Compact Flash card.

41. A method of hot unplugging a peripheral device from a host system by a user comprising the steps of:
pushing a push button coupled to a peripheral device controller to create an interrupt within the peripheral device controller;
initiating an interrupt service routine;
finishing all unfinished operations;
emptying all buffers and writing dirty caches to flash memory;
notifying the host system of a termination; and
turning on a LED coupled to the peripheral device controller to indicate to the user that the peripheral device can be unplugged.

42. A method of detecting the presence of a peripheral device by a dual mode host system comprising the steps of:
detecting the peripheral device;
sending a USB Reset command to the peripheral device;
sending a USB Read Status command to the peripheral device;
communicating with the peripheral device in a PCI Express mode if the peripheral device does not respond;
determining if the peripheral device is a dual mode device if the peripheral device responds;
communicating with the peripheral device in a USB mode if the peripheral device is not a dual mode device, else recognizing the peripheral device as a dual mode device;
sending an enable PCI Express mode command to the peripheral device;
sending a Read Status command to the peripheral device;
waiting fro a Ready command from the peripheral device;
determining if the PCI Express mode is ready; and
failing the peripheral device if the PCI Express mode is not ready, else communicating with the peripheral device in a PCI Express mode.

43. A method of detecting the presence of a peripheral device by a single mode host system comprising the steps of:
sending a Reset command to the peripheral device in a communication mode of the host system;
sending a Read Status command to the peripheral device in the communication mode of the hose system;
determining if the peripheral device responds to the host system;
failing the peripheral device if the peripheral device does not respond, else communicating with the peripheral device in the communication mode of the host system.

44. A method of detecting a communication mode of a host system by a dual mode peripheral device comprising the steps of:
powering on the peripheral device;
initializing the peripheral device;
waiting for a Reset command from the host system;
resetting the peripheral device;
waiting for a Read Status command from the host system;
determining if the host system is a dual mode device;
waiting for single mode communication from the host system if the host system is a single mode device, else responding to the host system indicating that the peripheral device is a dual mode device;
waiting for a PCI Express mode Enable command from the host system;
waiting for a Read Status command from the host system;
responding to the host system with an OK status; and
waiting for communication from the host system in PCI Express mode.

45. A method of detecting a communication mode of a host system by a dual mode peripheral device comprising the steps of:
powering on the peripheral device;
initializing the peripheral device;
waiting for a Reset command from the host system;
resetting the peripheral device;
waiting for a Read Status command from the host system;
determining if the peripheral device is a USB mode device;
communicating with the host system in USB mode if the peripheral device is a USB mode device, else communicating with the host system in PCI Express mode if the peripheral device is a PCI Express mode device.
